(19) United States
(12) Patent Application Publication
(10) Pub. No.: US 2015/0171581 A1
(43) Pub. Date: Jun. 18, 2015

(54) METAL-CARBONACEOUS BRUSH AND MANUFACTURING METHOD OF THE SAME

(71) Applicant: TOYO TANSO CO., LTD., Osaka (JP)

(72) Inventors: Shunsuke Morita, Kagawa (JP); Fumihiro Hozumi, Kagawa (JP); Yoshikazu Kagawa, Kagawa (JP); Hidenori Shirakawa, Kagawa (JP)

(73) Assignee: TOYO TANSO CO., LTD., Osaka (JP)

(21) Appl. No.: 14/409,253

(22) PCT Filed: Jun. 17, 2013
(86) PCT No.: PCT/JP2013/003770

§ 371 Date: Dec. 18, 2014

(30) Foreign Application Priority Data
Jun. 18, 2012 (JP) 2012-136494

(51) Int. Cl. H01R 39/02; B22F 5/00; B22F 3/10; H01R 43/12

(52) U.S. Cl. CPC H01R 39/025; H01R 43/12; B22F 5/00; B22F 3/10

(57) ABSTRACT

A carbonaceous material is fabricated by kneading of carbon powder and a binder. A particle diameter of the carbonaceous material is adjusted after the fabricated carbonaceous material is granulated. A brush material is fabricated by mixing of the carbonaceous material of which the particle diameter is adjusted and metal powder. A brush is completed by forming and thermal processing of the fabricated brush material. In this case, the particle diameter of the carbonaceous material is adjusted in a constant range before the carbonaceous material and the metal powder are mixed such that an average particle diameter of the carbonaceous material in the brush is not less than 300 μm and not more than 2000 μm. Alternatively, a ratio of the volume of the carbonaceous material having the particle diameter of not less than 300 μm to the volume of the brush is adjusted to not less than 50%.

### TECHNICAL FIELD

The present invention relates to a metal-carbonaceous brush used for a motor, and a manufacturing method of the metal-carbonaceous brush.

### BACKGROUND ART

A motor including a brush is used for various types of electrical instruments for domestic use and industrial use, automobiles, and the like. There is a metal-carbonaceous brush as a brush for a DC motor. For example, graphite powder and electrolytic copper powder are mixed, and then firing and pressure forming of the mixture are performed, whereby the metal-carbonaceous brush is fabricated (Patent Document 1, for example).

[Patent Document 1] JP 2010-193621 A

### SUMMARY OF INVENTION

### Technical Problem

In order to increase the output of the DC motor, it is required to decrease electrical resistivity of the metal-carbonaceous brush. As a method of decreasing the electrical resistivity of the metal-carbonaceous brush, a ratio of metal contained in the metal-carbonaceous brush is increased. However, when the ratio of metal is increased, friction force between the metal-carbonaceous brush and a commutator of the DC motor is increased. Therefore, the metal-carbonaceous brush and the commutator are likely to wear out.

Further, when frictional heat between the metal-carbonaceous brush and the commutator of the DC motor is large, or when Joulean heat in the metal-carbonaceous brush is large, the temperature of the metal-carbonaceous brush increases. When the metal-carbonaceous brush continues to be used at such high temperature, the metal included in the metal-carbonaceous brush is oxidized, so that the metal-carbonaceous brush irreversibly expands (hereinafter referred to as oxidation expansion). As a result, a defect such as an adherence of the metal carbonaceous brush to another member, or poor press of the metal carbonaceous brush against the commutator occurs.

An object of the present invention is to provide a metal-carbonaceous brush in which electrical resistivity is decreased while wear-out is inhibited, and a manufacturing method of the metal-carbonaceous brush. Further, an object of the present invention is to provide a metal-carbonaceous brush in which irreversible expansion due to oxidation of metal is inhibited.

### Solution to Problem

(1) According to one aspect of the present invention, a metal-carbonaceous brush includes a carbonaceous material made of a plurality of carbonaceous particles, and a good conductive portion provided in gaps among the plurality of carbonaceous particles and made of metal, wherein an average particle diameter of the plurality of carbonaceous particles is not less than 300 μm and not more than 2000 μm.

In this metal-carbonaceous brush, because a good conductive portion is provided in gaps formed among the carbonaceous particles, the electrical resistivity of a metal graphite brush can be decreased. In this case, because the average particle diameter of the plurality of carbonaceous particles is not less than 300 μm, the good conductive portion can be easily formed. Further, because the average particle diameter of the plurality of carbonaceous particles is not more than 2000 μm, forming of the brush can be easily performed.

Further, because it is not necessary to increase the ratio of metal, friction between the metal-carbonaceous brush and a contact portion of the motor is inhibited. Therefore, the wear-out of the metal-carbonaceous brush is inhibited.

(2) A ratio of the good conductive portion to a total of the carbonaceous material and the good conductive portion may be not less than 10% by weight and not more than 70% by weight.

In this case, because the ratio of the good conductive portion is not less than 10% by weight, the electrical resistivity of the metal-carbonaceous brush can be sufficiently decreased. Further, because the ratio of the good conductive portion is not more than 70% by weight, the wear-out of the metal-carbonaceous brush can be sufficiently inhibited.

(3) The good conductive portion may be formed using electrolytic copper powder. In this case, conductivity of the metal-carbonaceous brush can be ensured while an increase in cost is inhibited.

(4) According to another aspect of the present invention, a manufacturing method of a metal-carbonaceous brush includes the steps of fabricating a carbonaceous material by mixing of carbonaceous powder and a binder, adjusting a particle diameter of the fabricated carbonaceous material, mixing the carbonaceous material of which a particle diameter is adjusted and metal powder, forming the mixed carbonaceous material and metal powder, and baking the formed carbonaceous material and metal powder, wherein the particle diameter of the carbonaceous material is adjusted such that an average particle diameter of the carbonaceous material after forming and firing is not less than 300 μm and not more than 2000 μm, in the step of adjusting.

In this manufacturing method, the carbonaceous material and the metal powder are mixed after the particle diameter of the carbonaceous material is adjusted, whereby the average particle diameter of the carbonaceous material after forming and firing is not less than 300 μm and not more than 2000 μm. In this case, the average particle diameter of the carbonaceous material is not less than 300 μm, so that metal particles are intensively and successively arranged in gaps formed among the carbonaceous particles. Therefore, the plurality of metal particles are likely to come into contact with one another. Further, the metal particles that come into contact with one another are sintered and integrated. Thus, the electrical resistivity of the metal-carbonaceous brush can be decreased. Further, because the average particle diameter of the carbonaceous material is not more than 2000 μm, forming of the brush can be easily performed.

Further, because it is not necessary to increase a ratio of the metal powder, the friction between the metal-carbonaceous brush and the contact portion of the motor is inhibited. Therefore, the wear-out of the metal-carbonaceous brush is inhibited.

(5) Copper powder may be used as the metal powder in the step of mixing, and an average particle diameter of the copper powder mixed with the carbonaceous material may be not less than 1/200 and not more than 3/20 of the average particle diameter of the carbonaceous material after forming and firing.

In this case, the conductivity of the metal-carbonaceous brush can be sufficiently ensured, and the wear-out of the metal-carbonaceous brush can be sufficiently inhibited.

(6) Electrolytic copper powder may be used as the copper powder in the step of mixing. In this case, the conductivity of the metal-carbonaceous brush can be sufficiently ensured while an increase in cost is inhibited.

(7) A particle diameter of the electrolytic copper powder may be not less than 10 μm and not more than 40 μm. In this case, the conductivity of the metal-carbonaceous brush can be sufficiently ensured.

(8) According to yet another aspect of the present invention, a metal-carbonaceous brush includes a carbonaceous material made of a plurality of carbonaceous particles, and a good conductive portion provided in gaps among the plurality of carbonaceous particles and is made of metal, wherein a ratio of volume of the plurality of carbonaceous particles having a particle diameter of not less than 300 μm to volume of the brush is not less than 50%.

In this metal-carbonaceous brush, the ratio of the volume of the plurality of carbonaceous particles having the particle diameter of not less than 300 μm to the volume of the brush is not less than 50%. In this case, an area of the good conductive portion that comes into contact with oxygen decreases. Therefore, even when the metal-carbonaceous brush becomes hot, the good conductive portion is unlikely to be oxidized. Thus, the oxidation expansion of the metal-carbonaceous brush due to the oxidation of the good conductive portion can be inhibited. As a result, a defect such as an adherence of the metal-carbonaceous brush to another member or lack of pressure of the metal-carbonaceous brush against the commutator can be prevented from occurring.

(9) The ratio of the volume of the plurality of carbonaceous particles having the particle diameter of not less than 300 μm to the volume of the brush may be not less than 60% and not more than 90%.

In this case, the area of the good conductive portion that comes into contact with oxygen can be more sufficiently decreased while the electrical resistivity is decreased. Thus, the oxidation expansion of the metal-carbonaceous brush due to the oxidation of the good conductive portion can be more sufficiently inhibited.

### Advantageous Effects of Invention

The present invention enables the electrical resistivity of the metal-carbonaceous brush to be decreased, and the wear-out of the metal-carbonaceous brush to be inhibited. Further, the irreversible expansion of the metal-carbonaceous brush due to the oxidation of metal can be inhibited.

### BRIEF DESCRIPTION OF DRAWINGS

FIG. 1 is a schematic perspective view of a DC motor using a metal-carbonaceous brush according to the present embodiment.

FIG. 2 is a diagram for explaining a relation between a particle diameter of a carbonaceous material and electrical resistivity.

FIG. 3 is a diagram for showing surface conditions of brushes observed by a polarizing microscope.

FIG. 4 is a diagram showing the measurement results of the electrical resistivity.

FIG. 5 is a diagram showing the measurement results of expansivity.

### DESCRIPTION OF EMBODIMENTS

A metal-carbonaceous brush according to one embodiment of the present invention will be described below with reference to drawings.

### (1) Configuration of Brush

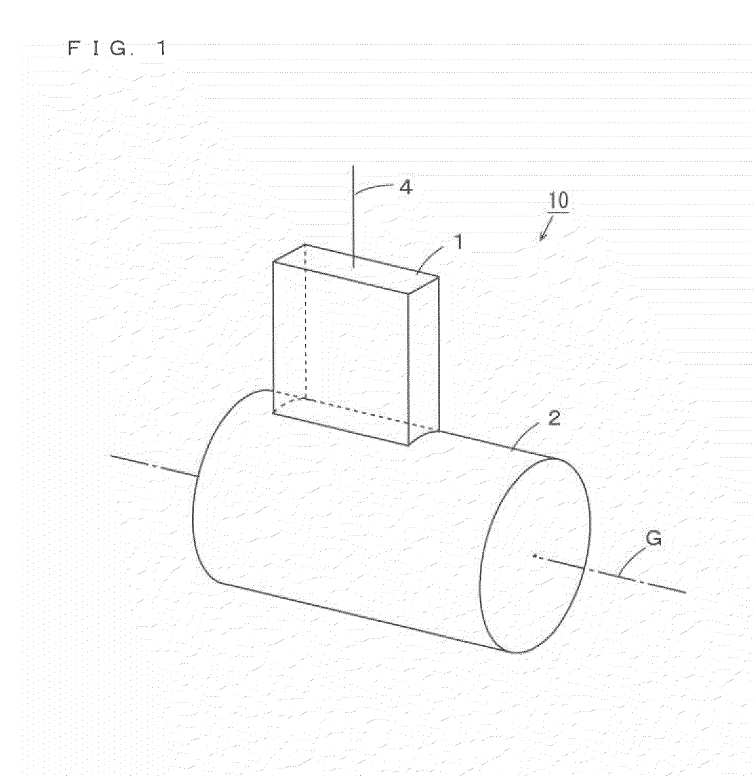

FIG. 1 is a schematic perspective view of a DC motor using the metal-carbonaceous brush (hereinafter abbreviated as a brush) according to the present embodiment. The DC motor 10 of FIG. 1 includes the brush 1 and a rotating body 2. The rotating body 2 is a commutator, and provided to be rotatable around a rotation axis G. A lead wire 4 is connected to the brush 1. One end of the brush 1 comes into contact with the outer peripheral surface of the rotating body 2. An electric current is supplied from a power source (not shown) to the brush 1 through the lead wire 4. The current is supplied from the brush 1 to the rotating body 2, so that the rotating body 2 is rotated around the rotation axis G. The brush rotating body 2 is rotated, so that the brush 1 slides with respect to the rotating body 2.

A carbonaceous material and metal powder are mixed and then formed, so that the brush 1 is fabricated. In the present embodiment, an average particle diameter of the carbonaceous material in the fabricated brush 1 is not less than 300 μm and not more than 2000 μm.

While the brush 1 is used for the DC motor 10 in the present embodiment, the invention is not limited to this. The brush 1 may be used for an AC motor.

### (2) Manufacturing Method of Brush

The manufacturing method of the brush 1 will be described. First, the carbonaceous material is fabricated by granulation. Specifically, carbon powder and a binder are kneaded such that the carbonaceous material is fabricated. As the carbon powder, graphite powder is preferably used. As the graphite powder, natural graphite powder, artificial graphite powder, expanded graphite powder or the like can be used, and a mixture of more than one of these may be used. As the binder, a synthetic resin can be used, any one of a thermosetting synthetic resin and a thermoplastic synthetic resin may be used, or a mixture of these may be used. As the preferable examples of the binder, these may be mentioned, an epoxy resin, a phenol resin, a polyester resin, a vinylester resin, a furan resin, a polyamide resin or a polyimide resin.

A ratio of the carbon powder to the total weight of the carbon powder and the binder is not less than 5% by weight and not more than 95% by weight, for example, and is preferably not less than 50% by weight and not more than 90% by weight.

During the kneading of the carbon powder and the binder, one or more types of tungsten, tungsten carbide, molybdenum and sulfides of tungsten, tungsten carbide and molybdenum may be added as an additive. A ratio of the additive to the total weight of the carbon powder and the binder is not less than 0.1% by weight and not more than 10% by weight, for example, and is preferably not less than 1% by weight and not more than 5% by weight.

Next, the fabricated carbonaceous material is granulated, and a particle diameter of the granulated carbonaceous material is adjusted. For example, carbonaceous particles having a particle diameter in a constant range are extracted from the carbonaceous material using a sieve and the like, whereby the particle diameter of the carbonaceous material is adjusted. The particle diameter of the carbonaceous material is preferably adjusted in the range larger than 300 μm and not more than 1700 μm. Further, the particle diameter of the carbonaceous material may be adjusted in the constant range by another method such as grinding of the carbonaceous material.

Then, the carbonaceous material of which the particle diameter is adjusted, and the metal powder are mixed such that a brush material is fabricated. A ratio of the metal powder to the total weight of the brush material is preferably not less than 10% by weight and not more than 70% by weight, for example. As the metal powder, copper powder is used, for example. Further, as the copper powder, electrolytic copper powder is preferably used. The apparent density of the electrolytic copper powder is preferably not less than 0.70 and not more than 1.20, and a particle diameter of the electrolytic copper powder is preferably not less than 10 μm and not more than 40 μm. As the copper powder, the copper powder fabricated by an atomizing method or a stamping method may be used instead of the electrolytic copper powder. Further, silver powder such as electrolytic silver powder, silver powder fabricated by the atomizing method or the stamping method, and the like may be used, and alternatively, another metal powder such as silver plating copper powder may be used, instead of the copper powder. Next, pressure forming of the fabricated brush material is performed. Thus, the particle diameter of the carbonaceous material in the brush material becomes smaller than the particle diameter of the carbonaceous material in the brush material before forming. The formed brush material is thermally processed at not less than 400° C. and not more than 900° C. in a nitrogen or ammonia reduction atmosphere or in a vacuum. Thus, the brush 1 is completed.

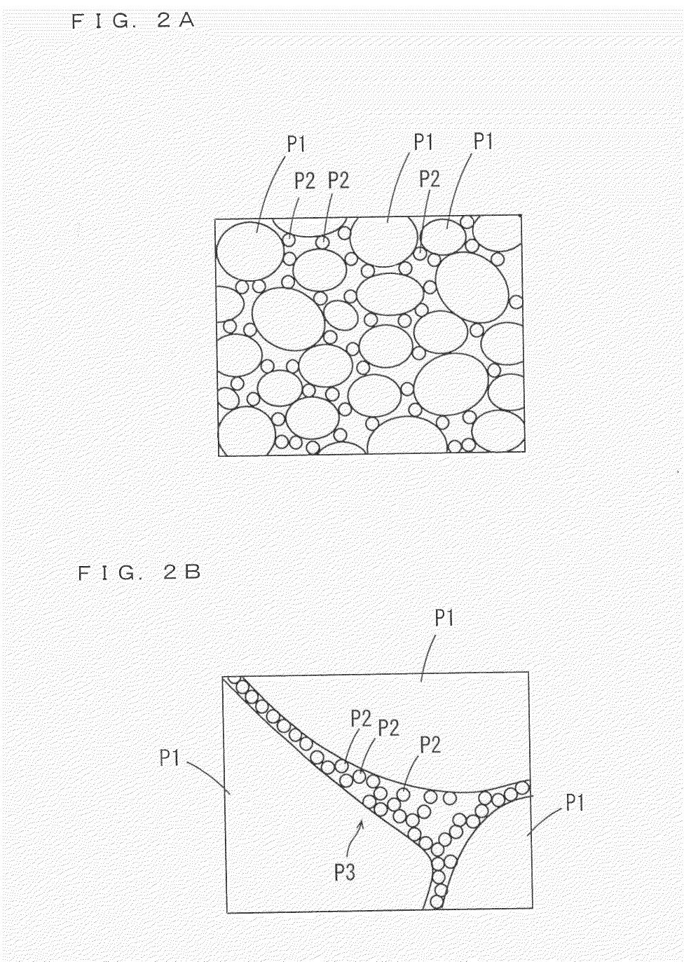

FIG. 2 is a diagram for explaining a relation between the particle diameter of the carbonaceous material after forming and firing (hereinafter referred to as a post-forming particle diameter) and electrical resistivity. In FIG. 2(a), conditions of the carbonaceous material obtained when the post-forming particle diameter of the carbonaceous material is relatively small and metal particles are shown. In FIG. 2(b), conditions of the carbonaceous material obtained when the post-forming particle diameter of the carbonaceous material is relatively large and the metal particles are shown.

For example, in a case in which the carbonaceous material is ground into excessively small pieces before the carbonaceous material and the metal powder are mixed, the post-forming particle diameter of the carbonaceous material is relatively small (not more than 100 μm, for example) as shown in FIG. 2(a). In this case, the plurality of carbonaceous particles P1 and the plurality of metal particles P2 are respectively dispersively arranged. Therefore, the plurality of metal particles P2 are unlikely to come into contact with one another, and the electrical resistivity of the brush 1 increases.

On the other hand, in the present embodiment, the particle diameter of the carbonaceous material is adjusted in a constant range before the carbonaceous material and the metal powder are mixed such that an average value of the post-forming particle diameter of the carbonaceous material (hereinafter referred to as a post-forming average particle diameter) is not less than 300 μm and not more than 2000 μm. The post-forming average particle diameter of the carbonaceous material is not less than 300 μm, so that the plurality of metal particles P2 are intensively and successively arranged in gaps formed among the plurality of carbonaceous particles P1, as shown in FIG. 2(b). Further, the metal particles P2 that are in contact with one another are sintered and integrated by the thermal processing, whereby a good conductive portion P3 is formed. The good conductive portion P3 has higher conductivity than a portion constituted by the carbonaceous material. Thus, the electrical resistivity of the brush 1 decreases.

Further, when the post-forming average particle diameter of the carbonaceous material is larger than 2000 μm, the forming of the brush 1 is difficult. Therefore, the post-forming average particle diameter of the carbonaceous material is not more than 2000 μm, so that the forming of the brush 1 can be easily performed while the electrical resistivity of the brush 1 is decreased.

A ratio of the volume of the carbonaceous material having the particle diameter of not less than 300 μm to the volume of the brush 1 is not less than 50%. Thus, an area of the good conductive portion P3 that comes into contact with oxygen can be decreased. The ratio of the volume of the carbonaceous material having the particle diameter of not less than 300 μm to the volume of the brush 1 is preferably not less than 60% and not more than 90%. In this case, the area of the good conductive portion P3 that comes into contact with oxygen can be more sufficiently decreased while the electrical resistivity is decreased.

The post-forming average particle diameter of the carbonaceous material is preferably not less than 400 μm and not more than 1500 μm, and is more preferably not less than 800 μm and not more than 1500 μm. Thus, the forming of the brush 1 can be more easily performed while the electrical resistivity of the brush 1 is sufficiently decreased. Further, when the copper powder is used as the metal powder, the average particle diameter of the copper powder before forming and firing is preferably not less than 1/200 and not more than 3/20, and is more preferably not less than 1/50 and not more than ⅕, with respect to the post-forming average particle diameter of the carbonaceous material. Thus, wear-out of the brush 1 can be sufficiently inhibited while the conductivity of the brush 1 is sufficiently ensured.

### (3) Effects

In this manner, in the present embodiment, the post-forming average particle diameter of the carbonaceous material is not less than 300 μm and not more than 2000 μm, so that the electrical resistivity of the brush 1 can be decreased and the forming of the brush 1 can be easily performed.

Further, because it is not necessary to increase a ratio of the metal powder in the mixture of the carbonaceous material and the metal powder, friction between the brush 1 and the rotating body 2 of the DC motor 10 is inhibited. Therefore, the wear-out of the brush 1 is inhibited.

Further, a ratio of the electrolytic copper powder used as the metal powder is not less than 10% by weight and not more than 70% by weight, so that the electrical resistivity of the brush 1 can be sufficiently decreased, and the wear-out of the brush 1 can be sufficiently inhibited.

Further, in the present embodiment, the ratio of the volume of the carbonaceous material having the particle diameter of not less than 300 μm to the volume of the brush 1 can be made not less than 50% by granulation. In this case, the plurality of metal particles P2 are arranged among the plurality of carbonaceous particles P1, so that an area of the plurality of metal particles P2 that comes into contact with oxygen decreases. Therefore, even when the brush 1 becomes hot, the metal is unlikely to be oxidized. Thus, irreversible expansion of the brush 1 due to the oxidation of metal (hereinafter referred to as oxidation expansion) can be inhibited. As a result, a defect such as an adherence of the brush 1 to another member such as a brush holder, or poor press of the brush 1 against the rotating body 2, can be prevented from occurring.

Further, in the present embodiment, the plurality of metal particles P2 can be arranged among the plurality of carbonaceous particles P1 while not being dispersed but coupled. In this case, because the area of the plurality of metal particles P2 that comes into contact with oxygen is more sufficiently decreased, the metal is more unlikely to be oxidized. Further, because the good conductive portion P3 is more efficiently formed by the plurality of coupled metal particles P2, the electrical resistivity of the brush 1 decreases. Thus, the ratio of the metal powder to the total weight of the brush material can be decreased. As a result, the oxidation expansion of the brush 1 can be more sufficiently decreased.

### (4) Inventive Examples and Comparative Example

### (4-1) Inventive Example 1

A phenol resin was added as a binder and molybdenum disulfide was added as an additive, to natural graphite, and then the mixture was kneaded at a room temperature, whereby a carbonaceous material was fabricated. The fabricated carbonaceous material was dried by a hot-air dryer. An average particle diameter of the natural graphite is 50 μm, and ash of the natural graphite is not more than 0.5%. A ratio of the natural graphite to the total weight of the natural graphite and the phenol resin is 85% by weight, and a ratio of the phenol resin is 15% by weight. A ratio of the molybdenum disulfide to the total weight of the natural graphite and the phenol resin is 3% by weight.

Next, the carbonaceous particles having the particle diameter larger than 710 μm and not more than 1400 μm were extracted from the dried carbonaceous material, whereby a particle diameter of the carbonaceous material was adjusted. Specifically, the carbonaceous particles that passed through a sieve with holes of 1400 μm and did not pass through a sieve with holes of 710 μm, were extracted using a granulator. Electrolytic copper powder was mixed in the carbonaceous material of which the particle diameter was adjusted, whereby the brush material was fabricated. The pressure forming of the fabricated brush material was performed. The formed brush material was thermally processed at 800° C. in an ammonia reduction atmosphere, whereby the brush 1 was fabricated. An average particle diameter of the electrolytic copper powder is 20 μm, and the apparent density is 1.00. Each ratio of the electrolytic copper powder to the total weight of the brush material (hereinafter referred to as a copper ratio) was set to 20% by weight, 30% by weight, 40% by weight and 50° A) by weight. Pressure during pressure forming is 2 t/cm².

### (4-2) Inventive Example 2

Except that the carbonaceous particles having the particle diameter larger than 1400 μm and not more than 1700 μm were extracted from the granulated carbonaceous material using sieves, the brush 1 was fabricated similarly to the above-mentioned inventive example 1.

### (4-3) Inventive Example 3

Except that the carbonaceous particles having the particle diameter larger than 300 μm and not more than 710 μm were extracted from the granulated carbonaceous material using sieves, the brush 1 was fabricated similarly to the above-mentioned inventive example 1.

### (4-4) Inventive Example 4

Except that the carbonaceous particles having the particle diameter of 800 μm were extracted from the granulated carbonaceous material using sieves, the brush 1 was fabricated similarly to the above-mentioned inventive example 1.

### (4-5) Comparative Example 1

The comparative example 1 is different from the above-mentioned inventive example 1 in the following respects. In the comparative example 1, the granulated carbonaceous material was ground by a grinder such that an average diameter was 70 μm. Thereafter, the brush material was fabricated by mixing of the electrolytic copper powder in the ground carbonaceous material, and the brush 1 was fabricated by firing of the fabricated brush material after the pressure forming.

### (5) Evaluation

### (5-1) Surface Condition

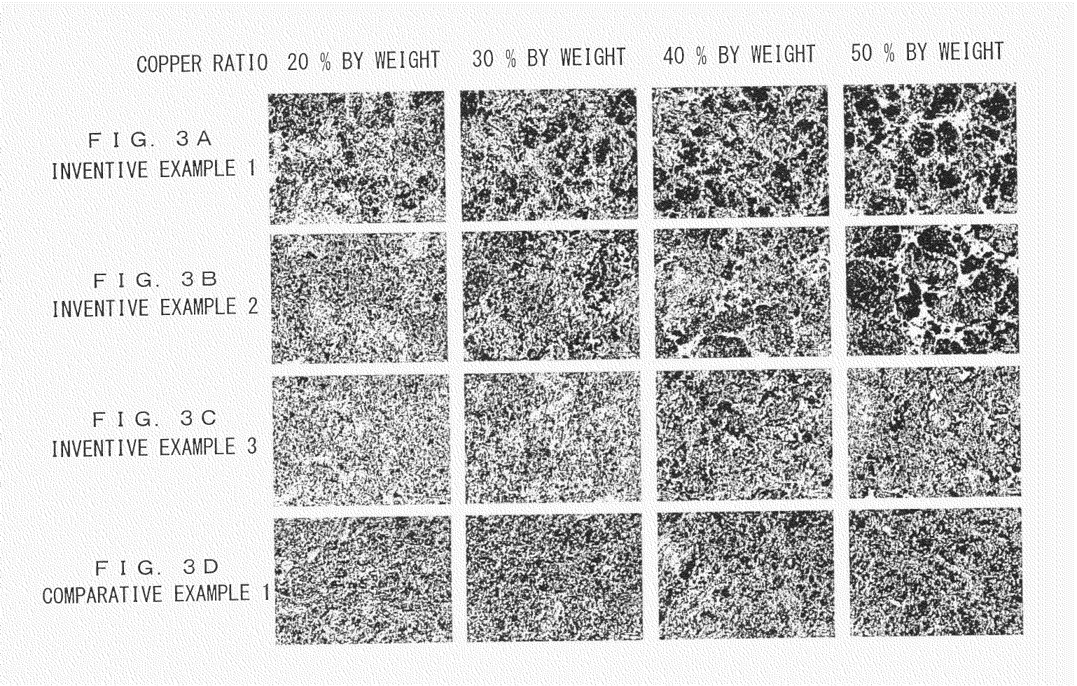

FIG. 3 is a diagram showing cross sectional views of the brush 1 observed by a polarizing microscope. In FIG. 3, conditions of the carbonaceous particles and the metal particles of the brushes 1 fabricated in the inventive examples 1 to 3 and the comparative example 1 are shown. It was found by the analysis of the microscopic images shown in FIG. 3 that the post-forming average particle diameter of the carbonaceous particles in the inventive example 1 was 800 μm, the post-forming average particle diameter of the carbonaceous particles in the inventive example 2 was 1500 μm, the post-forming average particle diameter of the carbonaceous particles in the inventive example 3 was 400 μm, and the post-forming average particle diameter of the carbonaceous particles in the comparative example 1 was 80 μm.

As shown in FIG. 3, in the inventive examples 1 to 3, it was found that a plurality of copper particles were intensively arranged in gaps formed among the plurality of carbonaceous particles, and further sintered and integrated, whereby a good conductive portion was formed. On the other hand, in the comparative example 1, it was found that the plurality of carbonaceous particles and the plurality of copper particles were respectively dispersively arranged.

### (5-2) Electrical Resistivity

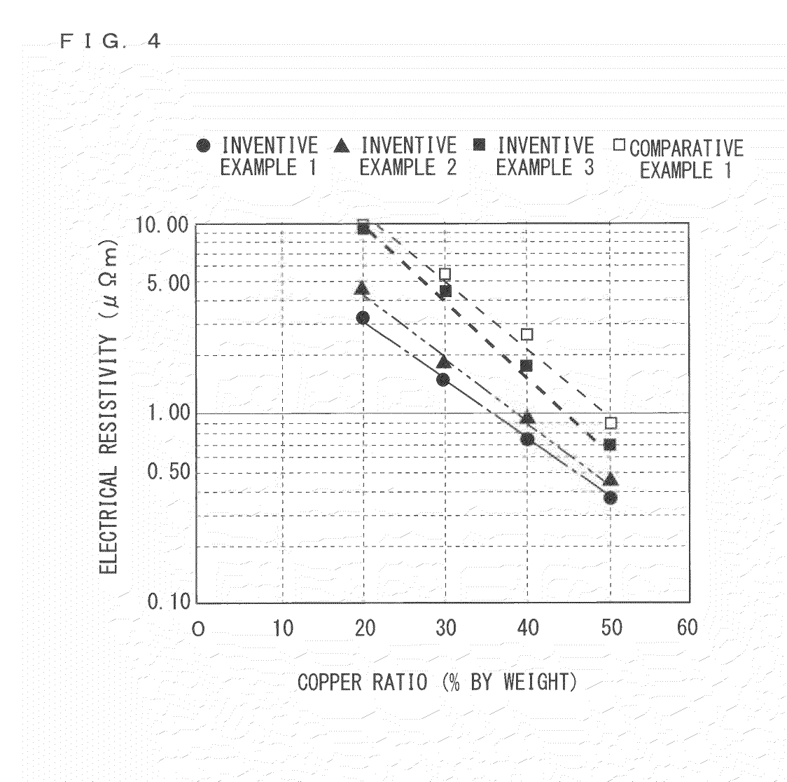

A test piece of 5 mm×5 mm×40 mm was fabricated from each of the brushes 1 fabricated in the inventive examples 1 to 3, and the comparative example 1, and the electrical resistivity of each test piece was measured. FIG. 4 is a diagram showing the measurement results of the electrical resistivity. As shown in FIG. 4, in each of the cases in which the copper ratio was 20% by weight, 30% by weight, 40% by weight and 50% by weight, the electrical resistivity of each of the test pieces of the inventive examples 1 to 3 was smaller than the electrical resistivity of the test piece of the comparative example 1. Further, in each of the cases in which the copper ratio was 20% by weight, 30% by weight, 40% by weight and 50% by weight, the electrical resistivity of each of the test pieces of the inventive examples 1, 2 was smaller than the electrical resistivity of the test piece of the inventive example 3.

Thus, it was found that the electrical resistivity of the brush 1 was decreased when the post-forming average particle diameter of the carbonaceous material was not less than 300 μm and not more than 2000 μm. Further, it was found that the electrical resistivity of the brush 1 was more sufficiently decreased when the post-forming average particle diameter of the carbonaceous material was not less than 800 μm and not more than 1500 μm.

### (5-3) Expansivity

A test piece of 7 mm×11 mm×11 mm was fabricated from each of the brushes 1 fabricated in the inventive example 4 and the comparative example 1, and the expansivity of each test piece due to the oxidation expansion was measured.

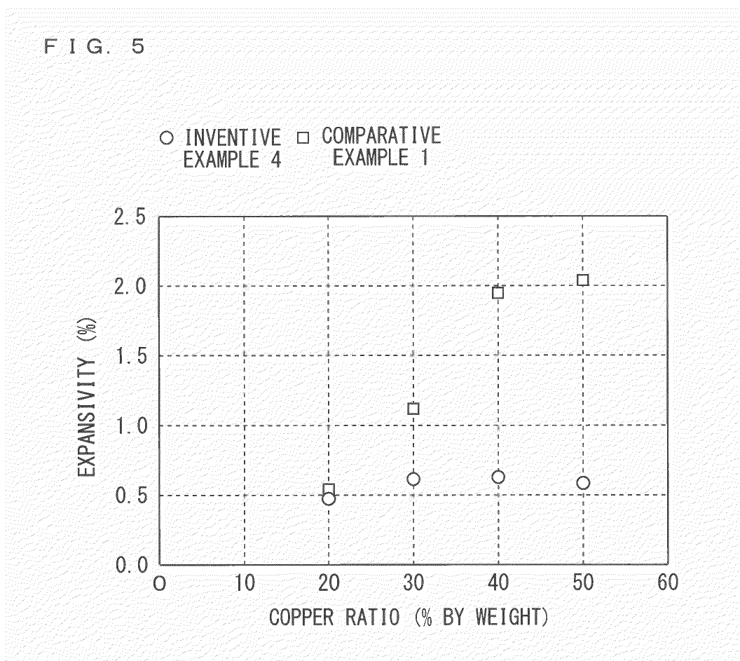

FIG. 5 is a diagram showing the measurement results of the expansivity. As shown in FIG. 5, in each of the cases in which the copper ratio was 20% by weight, 30% by weight, 40% by weight and 50% by weight, the expansivity of the test piece of the inventive example 4 was smaller than the expansivity of the test piece of the comparative example 1.

Similarly, a test piece was fabricated from each of the brushes 1 fabricated in the inventive examples 1 to 3, and the expansivity of each test piece due to the oxidation expansion was measured. As a result, the expansivity of each of the test pieces of the inventive examples 1 to 3 was smaller than the expansivity of the test piece of the comparative example 1.

Here, a ratio of the volume of the carbonaceous material having the particle diameter of not less than 300 μm to the volume of each of the test pieces in the inventive examples 1 to 3 was calculated by the analysis of the microscopic images shown in FIG. 3. The results are shown in Table 1.

TABLE 1

| | COPPER RATIO | | | |
|---|---|---|---|---|
| | 20% BY | 30% BY | 40% BY | 50% BY |
| | WEIGHT | WEIGHT | WEIGHT | WEIGHT |
| INVENTIVE | 85% | 79% | 77% | 70% |
| EXAMPLE 1 | | | | |
| AVERAGE | | | | |
| PARTICLE | | | | |
| DIAMETER | | | | |
| 800 μm | | | | |
| INVENTIVE | 85% | 81% | 77% | 71% |
| EXAMPLE 2 | | | | |
| AVERAGE | | | | |
| PARTICLE | | | | |
| DIAMETER | | | | |
| 1500 μm | | | | |
| INVENTIVE | 84% | 79% | 76% | 68% |
| EXAMPLE 3 | | | | |
| AVERAGE | | | | |
| PARTICLE | | | | |
| DIAMETER | | | | |
| 400 μm | | | | |

As shown in Table 1, in the inventive example 1, the ratios of the volume of the carbonaceous materials having the particle diameter of not less than 300 μm obtained when the copper ratio was 20% by weight, 30% by weight, 40% by weight and 50% by weight were 85%, 79%, 77% and 70%, respectively. In the inventive example 2, the ratios of the volume of the carbonaceous materials having the particle diameter of not less than 300 μm obtained when the copper ratio was 20% by weight, 30% by weight, 40% by weight and 50% by weight were 85%, 81%, 77% and 71%, respectively.

In the inventive example 3, the ratios of the volume of the carbonaceous materials having the particle diameter of not less than 300 μm obtained when the copper ratio was 20% by weight, 30% by weight, 40% by weight and 50% by weight were 84%, 79%, 76% and 68%, respectively. On the other hand, in the comparative example 1, the carbonaceous material having the particle diameter of not less than 300 μm was hardly present, or the ratio of the volume of the carbonaceous material having the particle diameter of not less than 300 μm to the volume of the brush 1 was smaller than 50%.

From the results of the inventive examples 1 to 3 and the comparative example 1, it was found that the expansion of the brush 1 due to the oxidation expansion of metal was reliably inhibited when the ratio of the volume of the carbonaceous material having the particle diameter of not less than 300 μm to the volume of the brush 1 was not less than 68% and not more than 85%.

### (6) Correspondences Between Constituent Elements in Claims and Parts in Preferred Embodiments

In the following paragraphs, non-limiting examples of correspondences between various elements recited in the claims below and those described above with respect to various preferred embodiments of the present invention are explained.

In the above-mentioned embodiment, the carbonaceous particles P1 are examples of carbonaceous particles, the metal particles P2 are examples of electrolytic copper powder, the good conductive portion P3 is an example of a good conductive portion and the brush 1 is an example of a metal-carbonaceous brush.

As each of constituent elements recited in the claims, various other elements having configurations or functions described in the claims can be also used.

### INDUSTRIAL APPLICABILITY

The present invention can be effectively utilized for various types of motors.

1. A metal-carbonaceous brush comprising:
a carbonaceous material comprising a plurality of carbonaceous particles; and
a good conductive portion provided in gaps among the plurality of carbonaceous particles and comprising a metal, wherein
an average particle diameter of the plurality of carbonaceous particles is not less than 300 μm and not more than 2000 μm, and
a ratio of the good conductive portion to a total of the carbonaceous material and the good conductive portion is not less than 10% by weight and not more than 70% by weight.

2. (canceled)

3. The metal-carbonaceous brush according to claim 1, wherein the good conductive portion is formed using electrolytic copper powder.

4. A manufacturing method of a metal-carbonaceous brush, the method comprising:
fabricating a carbonaceous material by mixing a carbonaceous powder and a binder;
adjusting a particle diameter of the fabricated carbonaceous material;
mixing the carbonaceous material of which a particle diameter is adjusted and a metal powder;
forming the mixed carbonaceous material and metal powder; and
firing the formed carbonaceous material and metal powder, wherein
a good conductive portion comprising a metal that is derived from the metal powder is formed in gaps among particles of the carbonaceous material, and a width of the good conductive portion is formed to be smaller than a particle diameter of the particles of the carbonaceous material, by adjusting the particle diameter of the carbonaceous material such that an average particle diameter of the carbonaceous material after forming and firing is not less than 300 μm and not more than 2000 μm, in the step of adjusting.

5. The manufacturing method according to claim 4, wherein the metal powder comprises a copper powder, and
an average particle diameter of the copper powder mixed with the carbonaceous material is not less than 1/200 and not more than 3/20 of the average particle diameter of the carbonaceous material after forming and firing.

6. The manufacturing method according to claim 5, wherein the copper powder comprises an electrolytic copper powder.

7. The manufacturing method according to claim 6, wherein a particle diameter of the electrolytic copper powder is not less than 10 μm and not more than 40 μm.

8. A metal-carbonaceous brush comprising:
a carbonaceous material comprising a plurality of carbonaceous particles; and
a good conductive portion provided in gaps among the plurality of carbonaceous particles and comprising a metal, wherein
a ratio of volume of the plurality of carbonaceous particles having a particle diameter of not less than 300 μm to volume of the brush is not less than 60% and not more than 90%, and
a ratio of the good conductive portion to a total of the carbonaceous material and the good conductive portion is not less than 10% by weight and not more than 70% by weight.

9. (canceled)

10. The metal-carbonaceous brush according to claim 1, wherein the ratio of the good conductive portion to the total of the carbonaceous material and the good conductive portion is not more than 50% by weight.

11. The metal-carbonaceous brush according to claim 1, wherein the ratio of the good conductive portion to the total of the carbonaceous material and the good conductive portion is not less than 20% by weight.

12. The metal-carbonaceous brush according to claim 1, wherein the ratio of the good conductive portion to the total of the carbonaceous material and the good conductive portion is not more than 50% by weight and not less than 20% by weight.

13. The metal-carbonaceous brush according to claim 8, wherein
the good conductive portion having a width smaller than a particle diameter of the carbonaceous particles is arranged around the carbonaceous particles having the particle diameter of not less than 300 μm.

14. The metal-carbonaceous brush according to claim 8, wherein
the ratio of the good conductive portion to the total of the carbonaceous material and the good conductive portion is not less than 20% by weight and not more than 50% by weight.

15. The metal-carbonaceous brush according to claim 8, wherein
the ratio of the volume of the plurality of carbonaceous particles having the particle diameter of not less than 300 μm to the volume of the brush is not less than 68% and not more than 85%.
